(19) United States
(12) Patent Application Publication
(10) Pub. No.: US 2016/0375905 A1
(43) Pub. Date: Dec. 29, 2016

(54) APPARATUS AND METHOD FOR CONTROLLING SPEED OF CACC SYSTEM

(71) Applicant: Hyundai Motor Company, Seoul (KR)

(72) Inventors: Jong Rok Park, Suwon (KR); Dong Gyu Noh, Dongducheon (KR); Cho Rong Ryu, Incheon (KR); Dae Sung Hwang, Hwaseong (KR); Hahk Rel Noh, Bucheon (KR); Su Lyun Sung, Anyang (KR)

(21) Appl. No.: 14/960,347

(22) Filed: Dec. 5, 2015

(30) Foreign Application Priority Data
Jun. 29, 2015 (KR) 10-2015-0092204

(51) Int. Cl. B60W 30/14

(52) U.S. Cl. CPC B60W 30/143; B60W 2420/52; B60W 2550/302; B60W 2550/408

(57) ABSTRACT

The present disclosure provides an apparatus and method for controlling a cooperative adaptive cruise control (CACC) system capable of reducing a width of deceleration and acceleration to improve fuel efficiency by collecting information on preceding vehicles which are being driven on the same lane and using the collected information to control speed of a vehicle, in the CACC system on the basis of vehicle to everything (V2X) communication and radar.

### CROSS-REFERENCE TO RELATED APPLICATION

This application claims the benefit of and priority to Korean Patent Application No. 10-2015-0092204, filed on Jun. 29, 2015 in the Korean Intellectual Property Office, the disclosure of which being incorporated herein in its entirety by reference.

### TECHNICAL FIELD

The present disclosure relates generally to an apparatus and method for controlling speed of a cooperative adaptive cruise control (CACC) system, and more particularly, to a technology of collecting information (e.g., line information) about preceding vehicles which are being driven in the same lane and using the collected information to control (e.g., accelerate and decelerate) speed of a vehicle, in a CACC system based on vehicle to everything (V2X) communication and radar.

### BACKGROUND

A smart cruise control (SCC) system is a system for maintaining a constant distance from a preceding vehicle. The SCC system provides a cruise function by which a vehicle is automatically driven at constant speed set by a driver while maintaining a constant distance from the preceding vehicle by sensing an environment in front of the vehicle using mounted radar sensors. Also, the SCC system provides a speed limit function of controlling speed of the vehicle so as not to exceed the speed set by the driver.

The SCC system allows for convenience in that the driver does not need to continuously manipulate the accelerator or brake pedals to adjust a driving speed of the vehicle. Further, the system prevents the vehicle from being driven at a speed greater than the set speed, thereby enhancing safe driving.

Meanwhile, a cooperative adaptive cruise control (CACC) system is a system for improving SCC performance by adding vehicle to everything (V2X) communication to the SCC system. The CACC system determines a speed limit of a road through vehicle to infrastructure (V2I) communication, receives information on a preceding vehicle driving in the same lane through vehicle to vehicle (V2V) communication, and then improves cruise control (CC) performance on the basis of the received information.

Since a conventional CACC system sets an immediately preceding vehicle a target vehicle and then adjusts a speed of the host vehicle based on the determined speed of the target vehicle, there can be a problem in that sudden acceleration or sudden start frequently occurs. That is, in a case in which a first preceding vehicle is followed by a second preceding vehicle, and the second preceding vehicle is followed by the host vehicle, since the conventional CACC system adjusts the speed of the host vehicle by considering only the speed of the second preceding vehicle, there can be a problem in that the sudden acceleration or the sudden start frequently occurs, as compared to a case in which the speed of the host vehicle is adjusted by considering speeds of both the first preceding vehicle and the second preceding vehicle.

### SUMMARY

The present disclosure has been made to solve the above-mentioned problems occurring in the related art while advantages achieved by the prior art are maintained intact.

An aspect of the present disclosure provides an apparatus and method for controlling a cooperative adaptive cruise control (CACC) system capable of reducing a width (e.g., range) of deceleration and acceleration to improve fuel efficiency by collecting information (e.g., line information) on preceding vehicles which are being driven on the same lane and using the collected information to control (e.g., accelerate and decelerate) speed of a vehicle, in the CACC system on the basis of vehicle to everything (V2X) communication and radar.

The object of the present disclosure is not limited to the above-mentioned object, and other objects and advantages of the present disclosure can be appreciated by the following description and will be clearly described by the embodiments of the present disclosure. In addition, it will be easily known that the objects and advantages of the present disclosure can be implemented by means shown in the appended claims and a combination thereof.

According to embodiments of the present disclosure, an apparatus for controlling a speed of a host vehicle using a cooperative adaptive cruise control (CACC) system includes: a transceiver configured to simultaneously receive, from two peripheral vehicles that precede the host vehicle, driving information and identification (ID) information for a first preceding vehicle of the two peripheral vehicles; a speed calculator configured to calculate a speed of a second preceding vehicle of the two peripheral vehicles, wherein the second preceding vehicle immediately precedes the host vehicle; and a controller configured to compare the driving information from each of the peripheral vehicles received through the transceiver with the speed of the second preceding vehicle calculated by the speed calculator to detect driving information corresponding to the second preceding vehicle among the received driving information and control the speed of the host vehicle based on the detected driving information of the second preceding vehicle and driving information of the first preceding vehicle corresponding to the detected driving information.

The controller may be further configured to simultaneously transmit the ID of the first preceding vehicle and ID of the second preceding vehicle when the controller transmits its own driving information to the peripheral vehicles.

The controller may be further configured to detect whether or not the driving information corresponds to the second preceding vehicle based on a correlation coefficient between the driving information of each of the peripheral vehicles and the speed of the second preceding vehicle.

The speed calculator may be further configured to calculate the speed of the second preceding vehicle based on a radar of the host vehicle.

The speed calculator may be further configured to calculate the speed of the second preceding vehicle based on a camera of the host vehicle.

Furthermore, according to embodiments of the present disclosure, a method for controlling a speed of a host vehicle using a cooperative adaptive cruise control (CACC) system includes: simultaneously receiving, by a transceiver, driving information and identification (ID) information from two peripheral vehicles that precede the host vehicle for a first preceding vehicle of the two peripheral vehicles; calculating, by a speed calculator, a speed of a second preceding vehicle of the two peripheral vehicles, wherein the second preceding vehicle immediately precedes the host vehicle; comparing, by a controller, the driving information from each of the peripheral vehicles received through the transceiver with the speed of the second preceding vehicle calculated by the speed calculator to detect driving information corresponding to the second preceding vehicle among the received driving information; and controlling, by the controller, the speed of the host vehicle based on the detected driving information of the second preceding vehicle and driving information of the first preceding vehicle corresponding to the detected driving information.

The method may further include simultaneously transmitting, by the controller, the ID of the first preceding vehicle and ID of the second preceding vehicle when the controller transmits its own driving information to the peripheral vehicles.

The method may further include detecting, by the controller, whether or not the driving information corresponds to the second preceding vehicle is detected based on a correlation coefficient between the driving information of each of the peripheral vehicles and the speed of the second preceding vehicle.

The method may further include calculating, by the speed calculator, the speed of the second preceding vehicle based on a radar of the host vehicle.

The method may further include calculating, by the speed calculator, the speed of the second preceding vehicle based on a camera of the host vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is an illustrative diagram of a cooperative adaptive cruise control (CACC) system to which the present disclosure is applied.

FIG. 2 is a configuration diagram of an example of an apparatus for controlling speed of a CACC system according to the present disclosure.

FIG. 3 is a diagram illustrating an example of a process of controlling speed of a CACC system according to the present disclosure.

FIG. 4 is an illustrative diagram of a calculation period of a correlation coefficient according to the present disclosure.

FIG. 5 is a flow chart of an example of a method for controlling speed of a CACC system according to the present disclosure.

### DETAILED DESCRIPTION

The above-mentioned objects, features, and advantages will become obvious from the detailed description which is described below in detail with reference to the accompanying drawings. Therefore, those skilled in the art to which the present disclosure pertains may easily practice a technical idea of the present disclosure. Further, in describing the present disclosure, in the case in which it is judged that a detailed description of a well-known technology associated with the present disclosure may unnecessarily make the gist of the present disclosure unclear, it will be omitted. Hereinafter, embodiments of the present disclosure will be described in detail with reference to the accompanying drawings.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

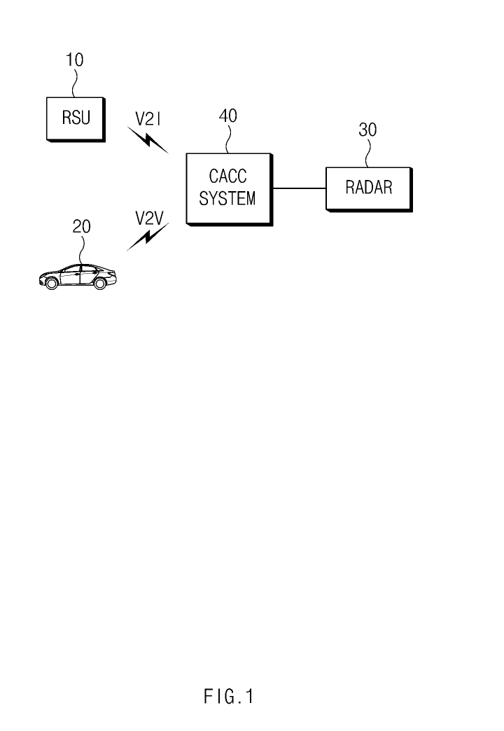

Referring now to the disclosed embodiments, FIG. 1 is an illustrative diagram of a cooperative adaptive cruise control (CACC) system to which the present disclosure is applied.

As illustrated in FIG. 1, a CACC system (40) applied to the present disclosure receives a speed limit of a road which is frequently changed depending on a road situation from a road-side unit (RSU) 10 on the basis of V2I communication.

In addition, the CACC system 40 receives driving information (e.g., speed, acceleration, and the like) from one or more peripheral vehicles 20. Here, the driving information includes identification (ID) information about preceding vehicles (alternatively referred to herein as “target vehicles”) of the peripheral vehicle which transmits the driving information as well as identification (ID) information that informs a source of the driving information.

For example, in the case in which a first preceding vehicle ID-1 is followed by a second preceding vehicle ID-2, and the second preceding vehicle is followed by a host vehicle ID-3, when the host vehicle receives driving information (e.g., speed, acceleration, and the like) from the second preceding vehicle ID-2, the host vehicle also receives information ID-1 informing that the first preceding vehicle is in front of the second preceding vehicle.

Particularly, the CACC system 40 compares the driving information received from the one or more peripheral vehicles 20 with speed of the preceding vehicle calculated on the basis of a radar 30 to detect the driving information matched to the preceding vehicle. That is, the CACC system 40 detects the driving information matched to the preceding vehicle among a plurality of driving information.

Thereafter, the CACC system 40 controls speed of the host vehicle on the basis of driving information of the first preceding vehicle and driving information of the second preceding vehicle. That is, since the CACC system 40 may recognize an existence of the second preceding vehicle using the driving information of the first preceding vehicle and may determine the ID of the second preceding vehicle, and the CACC system 40 may use the ID among the plurality of driving information to control the speed of the host vehicle.

Although the present disclosure describes the radar 30 by way of example, the speed of the preceding vehicle may also be calculated on the basis of a camera (not illustrated).

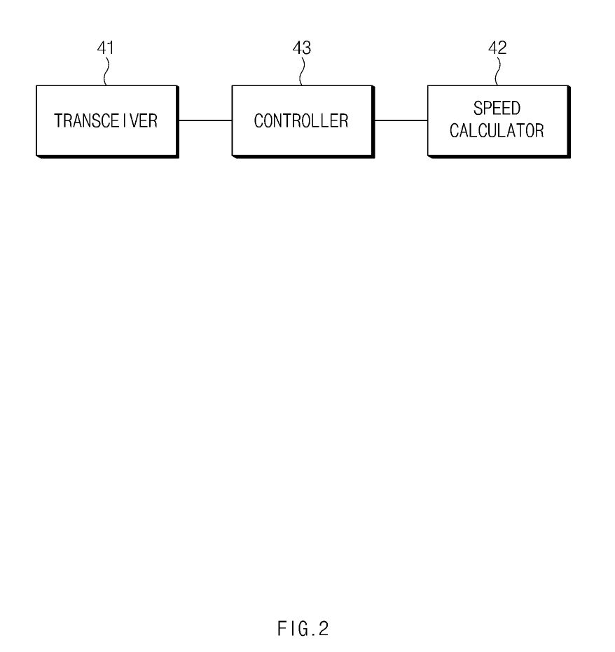

FIG. 2 is a configuration diagram of an example of an apparatus for controlling speed of a CACC system according to the present disclosure.

As illustrated in FIG. 2, the apparatus for controlling speed of a CACC system according to the present disclosure includes a transceiver 41, a speed calculator 42, and a controller 43.

The respective components will be described. First, the transceiver 41 receives driving information (e.g., speed, acceleration, and the like) from at least one or more peripheral vehicles 20 on the basis of V2V communication. Here, the driving information includes ID. In addition, the transceiver 41 receives speed limit of a road from the RSU 10 on the basis of V2I communication.

Next, the speed calculator 42 calculates speed of the preceding vehicle on the basis of the radar 30. That is, the speed calculator 42 calculates the speed of the preceding vehicle using a distance from the preceding vehicle obtained by the radar 30 and the speed of the host vehicle.

Next, the controller 43 performs a general control so that the respective components may normally perform own functions.

Particularly, the controller 43 compares the driving information of the one or more peripheral vehicles received through the transceiver 41 with the speed of the preceding vehicle calculated by the speed calculator 42 to detect driving information corresponding to the preceding vehicle among the driving information. Here, the controller 43 may know the ID of the preceding vehicle, as well as the speed and acceleration of the preceding vehicle using the detected driving information.

Therefore, the controller 43 may control the speed of the host vehicle on the basis of the driving information of all of the preceding vehicles. In addition, the controller 43 transmits the driving information of all of the preceding vehicles to following vehicles through the transceiver 41.

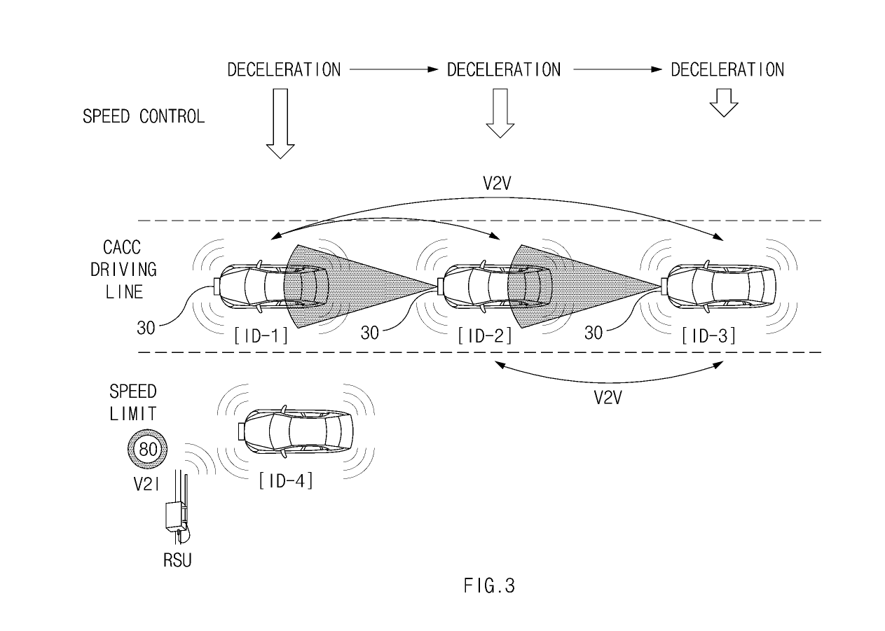

Hereinafter, an operation of the controller 43 will be described in more detail with reference to FIG. 3.

As illustrated in FIG. 3, in a driving line, there is an order of a lead preceding vehicle [ID-1] at the head, a preceding vehicle [ID-2] following the lead preceding vehicle [ID-1], and the host vehicle [ID-3]. That is, on the basis of the host vehicle [ID-3], the immediately preceding vehicle of the host vehicle is [ID-2] and the preceding vehicle of vehicle [ID-2] is vehicle [ID-1]. Since vehicle [ID-4] is not driven on the same lane as that of the host vehicle [ID-3], it is not considered a preceding vehicle.

The vehicle [ID-1], the vehicle [ID-2], and the host vehicle [ID-3] may transmit and receive the driving information thereof with each other through V2V communication. Particularly, when each vehicle transmits its own driving information, each vehicle also transmits ID information on its own preceding vehicle. That is, since a preceding vehicle of the vehicle [ID-1] is not present, the vehicle [ID-1] transmits only its own driving information, while the vehicle [ID-2] transmits information about its preceding vehicle [ID-1] together with its own driving information. Therefore, the host vehicle receives information of vehicle [ID-1] together with the driving information of the vehicle [ID-2].

In addition, the host vehicle needs to determine whether or not the vehicle [ID-2] is its own preceding vehicle. To this end, the host vehicle compares the driving information of the vehicle [ID-2] with the speed of its immediately preceding vehicle [ID-2] calculated on the basis of a radar 30 to determine whether or not there is the preceding vehicle. The determination may be made by comparing data of accumulated samples rather than comparing data of one sample.

As an example, after a correlation coefficient is calculated on the basis of the following Equation 1 and Equation 2, whether or not there is a preceding vehicle may be determined on the basis of the calculated correlation coefficient.

V_{TV}(N)=Vᵢ(N)+aᵢ(N)Δt→V_{TV}(N)−Vᵢ(N)=aᵢ(N)Δt→ΔVᵢ(N)=aᵢ(N)Δt [Equation 1]

Here, N means the number of samples for measuring variation of speed and acceleration, V_{TV}(N) means speed at an N-th sample of the preceding vehicle calculated on the basis of the radar 30, Vᵢ(N) means speed at the N-th sample among the driving information received from a peripheral vehicle (i), aᵢ(N) means acceleration at the N-th sample among the driving information received from the peripheral vehicle (i), and Δt means a time difference between a sample value on the basis of the driving information received from the peripheral vehicle (i) and a speed sample value on the basis of the radar.

$${r}_{i} ( N ) = \frac{{\sum }_{n = 1}^{N} ( Δ {V}_{i} ( n ) - \overline{Δ {V}_{i}} ) ( {a}_{i} ( n ) - \overline{{a}_{i}} )}{\sqrt{{\sum }_{n = 1}^{N} {( Δ {V}_{i} ( n ) - \overline{Δ {V}_{i}} )}^{2}} \sqrt{{\sum }_{n = 1}^{N} {( {a}_{i} ( n ) - \overline{{a}_{i}} )}^{2}}} \qquad [ Equation 2 ]$$

Δ̅V̅ᵢ:Average Value of ΔVᵢ for N Samples

āᵢ: Average Value of aᵢ for N Samples

Here, −1<r<1 is satisfied.

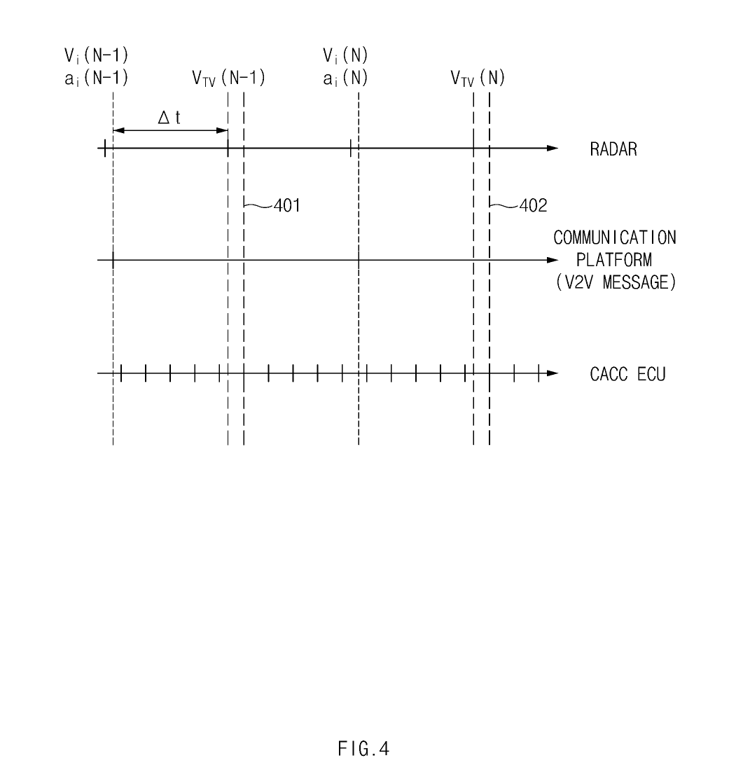

Meanwhile, a storing period for the N samples is illustrated in FIG. 4.

FIG. 4 is an illustrative diagram of a calculation period of a correlation coefficient according to the present disclosure and illustrates a case in which a data sampling period by the radar 30 is 50 ms, and a sampling period of a V2V message is 100 ms.

In FIG. 4, reference numeral ‘401’ denotes a timing at which an N−1-th sample value is stored, and reference numeral ‘402’ denotes a timing at which an N-th sample value is stored and the correlation coefficient is also calculated.

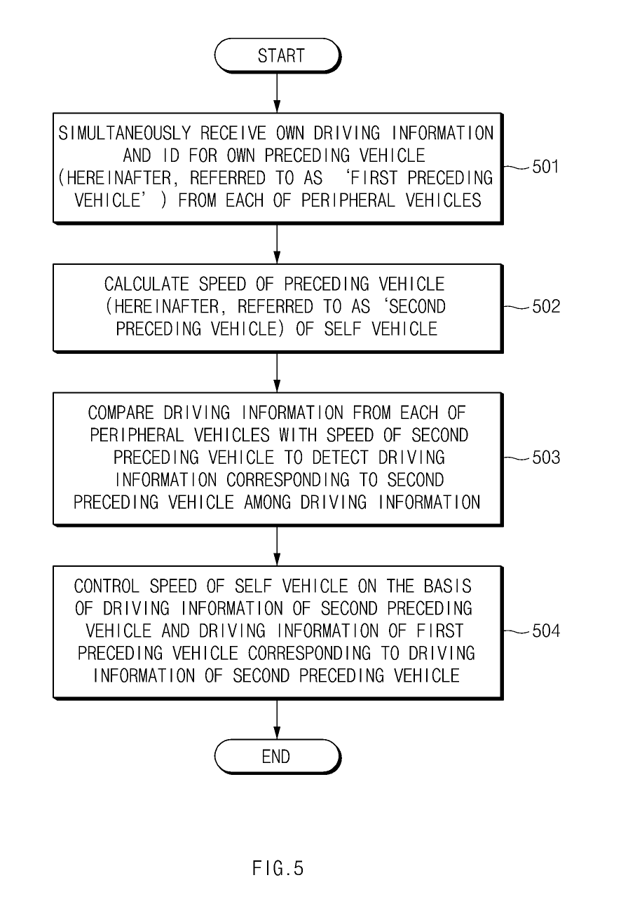

FIG. 5 is a flow chart of an example of a method for controlling speed of a CACC system according to the present disclosure.

First, the transceiver 41 simultaneously receives its own driving information and ID for its own preceding vehicle (hereinafter, referred to as “first preceding vehicle”) from each of the peripheral vehicles (501).

Next, the speed calculator 42 calculates speed of a preceding vehicle (hereinafter, referred to as “second preceding vehicle”) of the host vehicle (i.e., “self vehicle”) (502).

Next, the controller 43 compares the driving information of each of the peripheral vehicles received through the transceiver 41 with the speed of the second preceding vehicle calculated by the speed calculator 42 to detect driving information corresponding to the second preceding vehicle among the driving information (503).

Thereafter, the controller 43 controls speed of the host vehicle (i.e., “self vehicle”) on the basis of the detected driving information of the second preceding vehicle and driving information of the first preceding vehicle corresponding to the detected driving information (504).

The method according to the present disclosure as described above may be created by a computer program. In addition, codes and code segments configuring the computer program may be easily deduced by computer programmers in the art. In addition, the created computer program is stored in a computer readable recording medium (i.e., information storage medium) and is read and executed by computers, thereby implementing the method according to the present disclosure. In addition, the recording medium includes all forms of computer readable recording medium.

As described above, according to the embodiments of the present disclosure, the width (e.g., range) of deceleration and acceleration may be reduced and the fuel efficiency may be improved by collecting the information (e.g., line information) on the preceding vehicles which are being driven on the same lane and using the collected information to control (e.g., accelerate and decelerate) speed of the vehicle, in the CACC system on the basis of vehicle to everything (V2X) communication and radar.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a speed of a host vehicle using a cooperative adaptive cruise control (CACC) system, the apparatus comprising:
a transceiver configured to simultaneously receive, from two peripheral vehicles that precede the host vehicle, driving information and identification (ID) information for a first preceding vehicle of the two peripheral vehicles;
a speed calculator configured to calculate a speed of a second preceding vehicle of the two peripheral vehicles, wherein the second preceding vehicle immediately precedes the host vehicle; and
a controller configured to compare the driving information from each of the peripheral vehicles received through the transceiver with the speed of the second preceding vehicle calculated by the speed calculator to detect driving information corresponding to the second preceding vehicle among the received driving information and control the speed of the host vehicle based on the detected driving information of the second preceding vehicle and driving information of the first preceding vehicle corresponding to the detected driving information.

2. The apparatus according to claim 1, wherein the controller is further configured to simultaneously transmit the ID of the first preceding vehicle and ID of the second preceding vehicle when the controller transmits its own driving information to the peripheral vehicles.

3. The apparatus according to claim 1, wherein the controller is further configured to detect whether or not the driving information corresponds to the second preceding vehicle based on a correlation coefficient between the driving information of each of the peripheral vehicles and the speed of the second preceding vehicle.

4. The apparatus according to claim 1, wherein the speed calculator is further configured to calculate the speed of the second preceding vehicle based on a radar of the host vehicle.

5. The apparatus according to claim 1, wherein the speed calculator is further configured to calculate the speed of the second preceding vehicle based on a camera of the host vehicle.

6. A method for controlling a speed of a host vehicle using a cooperative adaptive cruise control (CACC) system, the method comprising:
simultaneously receiving, by a transceiver, driving information and identification (ID) information from two peripheral vehicles that precede the host vehicle for a first preceding vehicle of the two peripheral vehicles;
calculating, by a speed calculator, a speed of a second preceding vehicle of the two peripheral vehicles, wherein the second preceding vehicle immediately precedes the host vehicle;
comparing, by a controller, the driving information from each of the peripheral vehicles received through the transceiver with the speed of the second preceding vehicle calculated by the speed calculator to detect driving information corresponding to the second preceding vehicle among the received driving information; and
controlling, by the controller, the speed of the host vehicle based on the detected driving information of the second preceding vehicle and driving information of the first preceding vehicle corresponding to the detected driving information.

7. The method according to claim 6, further comprising simultaneously transmitting, by the controller, the ID of the first preceding vehicle and ID of the second preceding vehicle when the controller transmits its own driving information to the peripheral vehicles.

8. The method according to claim 6, further comprising detecting, by the controller, whether or not the driving information corresponds to the second preceding vehicle is detected based on a correlation coefficient between the driving information of each of the peripheral vehicles and the speed of the second preceding vehicle.

9. The method according to claim 6, further comprising calculating, by the speed calculator, the speed of the second preceding vehicle based on a radar of the host vehicle.

10. The method according to claim 6, further comprising calculating, by the speed calculator, the speed of the second preceding vehicle based on a camera of the host vehicle.
